(19) United States
(12) Patent Application Publication
(10) Pub. No.: US 2014/0122684 A1
(43) Pub. Date: May 1, 2014

(54) EARLY ACCESS TO USER-SPECIFIC DATA FOR BEHAVIOR PREDICTION

(71) Applicants: James August Burke Brentano, Orinda, CA (US); Eric Alan Johannsen, San Juan Capistrano, CA (US)

(72) Inventors: James August Burke Brentano, Orinda, CA (US); Eric Alan Johannsen, San Juan Capistrano, CA (US)

(73) Assignee: BLUECAVA, INC., Irvine, CA (US)

(21) Appl. No.: 14/127,871

(22) PCT Filed: Jul. 2, 2012
(86) PCT No.: PCT/US2012/045209

§ 371 Date: Jan. 14, 2014

Related U.S. Application Data
(60) Provisional application No. 61/504,122, filed on Jul. 1, 2011.

(51) Int. Cl. H04L 29/06

(52) U.S. Cl. CPC H04L 29/06
USPC 709/223

(57) ABSTRACT

A device-indexed data server associates persistent device identifiers of client computing devices with user behavior data devoid of personally identifiable information (PII). User behavior data and PII are aggregated by an off-line data aggregator and associated with non-persistent non-PII user identifiers. Users visiting third party web sites are authenticated by their device identifiers, and identified to the device-indexed data server by the device identifier or by the non-PII user identifier. The device-indexed data server retrieves from the aggregator user behavior data associated with the non-PII user identifier, returns the data to the third party server, and maintains records of user behavior associated with persistent device identifiers without maintaining PII. Subsequent user visits to any third party server can thereby be customized according to known user behavior without first requiring the user to identify herself.

### CROSS REFERENCE TO RELATED APPLICATION

This application is a U.S. national stage of International Application No. PCT/US2012/045209 filed Jul. 2, 2012, which claims priority to U.S. Ser. No. 61/504,122, titled “Early Access To User-Specific Data For Behavior Prediction,” filed Jul. 1, 2011, the disclosure of which is hereby incorporated by reference in its entirety.

### FIELD

The disclosed subject matter relates generally to network-based computer services and, more particularly, to methods of and systems for providing early access to user-specific data for user behavior prediction and provision of an enhanced user experience.

### BACKGROUND

One of the more important benefits of the current Internet-based world in which we live is mass customization. Exploitation of the mass customization afforded by intelligent interaction with customers through the Internet has led to a large number of successful “long tail” business models. Thus, the ability to customize the experience of each user of Internet-based services is now well-recognized as very important and very valuable.

Of course, such customization requires identification of the user before the experience can be customized for that user. Accordingly, the user's experience is rather generic until the user has taken the additional step of identifying herself. In addition, identification of the user typically involves what is generally known as personally identifiable information (PII). While many users enjoy the heavily customized experience, many also perceive the aggregation and storage of PII to be a bit creepy and to present significant privacy concerns. As a result, the law in this area is currently in a state of flux and varies according to jurisdiction. This raises significant uncertainty for business models that rely on capturing PII data capture.

In many cases, aggregation of PII is performed by servers that are carefully configured to safeguard the privacy of the PII and to use such PII only in legally appropriate ways. Such servers are sometimes referred to as off-line data aggregators. The management of these specialized servers and the manner in which they safeguard and disseminate data are continuously subject to revision for compliance with developing privacy laws. Such management significantly raises the overhead costs of operating as an off-line data aggregator of PII.

Given these costs and related risks, a network-based business model which has a primary purpose other than aggregation of PII could benefit from technology that exploits the value of PII without assuming the attendant liability.

### SUMMARY

In accordance with the disclosed subject matter, the observation that individual computer devices tend to be used by just a few, and often only one, user is leveraged to provide user behavior data based on the identity of the device alone. As a result, the user's experience can be customized according to prior behavior of the user prior to the user being identified directly through PII.

When first interacting with a user through a client device, a server obtains an identifier of the client device, e.g., a digital fingerprint of the client device, and uses the identifier of the client device to request data representing prior behavior of the user. To reduce privacy concerns, the data requested can be non-PII data.

Data of user behavior aggregated by an off-line data aggregator is associated with device identifiers of client devices through which users are authenticated. As a result, a record is maintained of user behavior through each client device. Therefore, subsequent interaction with the server can be customized by using the identifier of the client device to retrieve data representing previous behavior of the user to enable customization of the user's experience according to the previous behavior without first requiring the user to identify herself.

### BRIEF DESCRIPTION OF THE DRAWINGS

Other systems, methods, features and advantages of the disclosed subject matter will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features. In the drawings, like reference numerals may designate like parts throughout the different views, wherein:

FIG. 1 is a diagram showing a client computer, a server computer, an off-line data aggregator, and a device-indexed data server that cooperate to provide a customized user experience prior to user authentication in accordance with one embodiment of the disclosed subject matter.

FIG. 2 is a transaction diagram illustrating one embodiment according to the disclosed subject matter of a method by which the device-indexed data server and server computer of FIG. 1 cooperate to provide a customized user experience through the client prior to user authentication.

FIG. 3 is a logic flow diagram showing a step of the transaction flow diagram of FIG. 2 in greater detail.

FIG. 4 is a block diagram showing the device-indexed data server of FIG. 1 in greater detail.

FIG. 5 is a block diagram of a device-indexed user data record managed by the device-indexed data server of FIG. 4 in greater detail.

FIG. 6 is a transaction diagram illustrating one embodiment according to the disclosed subject matter of a method by which the device-indexed data server, off-line data aggregator, and server computer of FIG. 1 cooperate to record an association of the user and the client computer device of FIG. 1 for later use in the manner shown in FIG. 2.

FIG. 7 is a transaction diagram illustrating one embodiment according to the disclosed subject matter of a method by which the device-indexed data server and server computer of FIG. 1 cooperate to record an association of the user and the client computer device of FIG. 1 for later use in the manner shown in FIG. 2.

### DETAILED DESCRIPTION

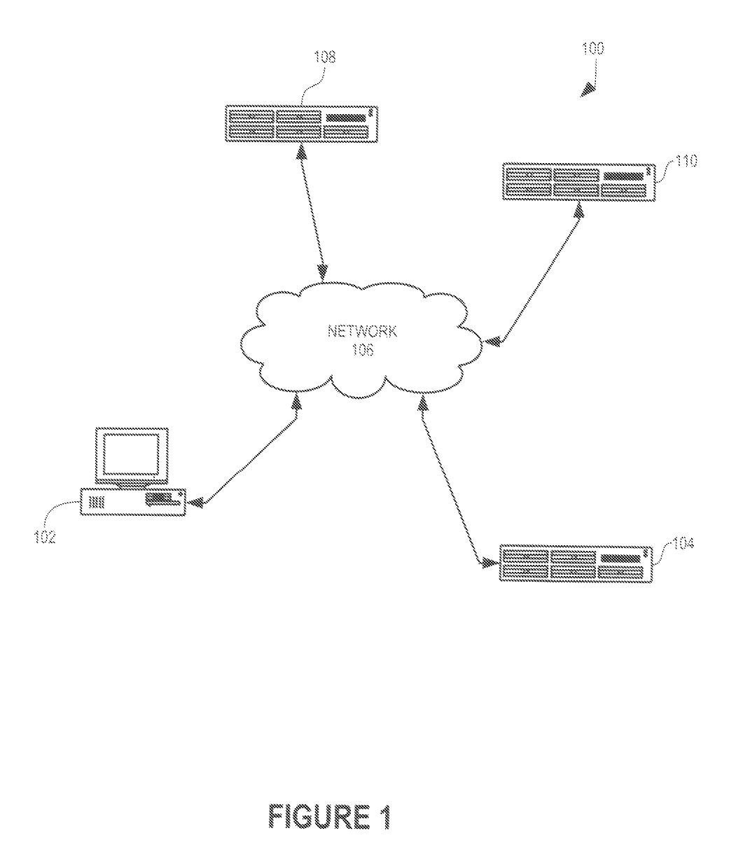

In accordance with the disclosed subject matter, a server 104 (FIG. 1) has access to data about a user of a client device 102 prior to authentication or even identification of the user and can therefore customize the experience of the user prior to authentication or identification. In particular, a device-indexed data server 108 associates data about the user from an off-line data aggregator 110 with a device identifier of client device 102 and makes that data available to server 104. To properly protect the privacy of the user, device-indexed data server 108 associates the device identifier of client device 102 with only non-PII data, i.e., data that is not personally identifiable information (PII). As used herein, personally identifiable information is information that can be used to distinguish or trace an individual's identity—such as the individual's name, age, gender, social security number, date of birth, driver's license number, street address, e-mail address, biometric records, etc.—either alone or when combined with other personal or identifying information that is linked or linkable to a specific individual, such as the individual's place of birth and the individual's mother's maiden name, to name a few.

FIG. 1 shows client device 102 connected to server 104, device-indexed data server 108, and off-line data aggregator 110 through a wide area network 106 such as the Internet. Client device 102 can be any computing device capable of carrying on user interaction through wide area network 106. Server 104 provides a network-based service and customizes the user experience of the service according to data about the user aggregated by off-line data aggregator 110. From the user's point of view, the user interacts through client device 102 directly with server 104 and is unaware of the related interactions of servers 108 and 110.

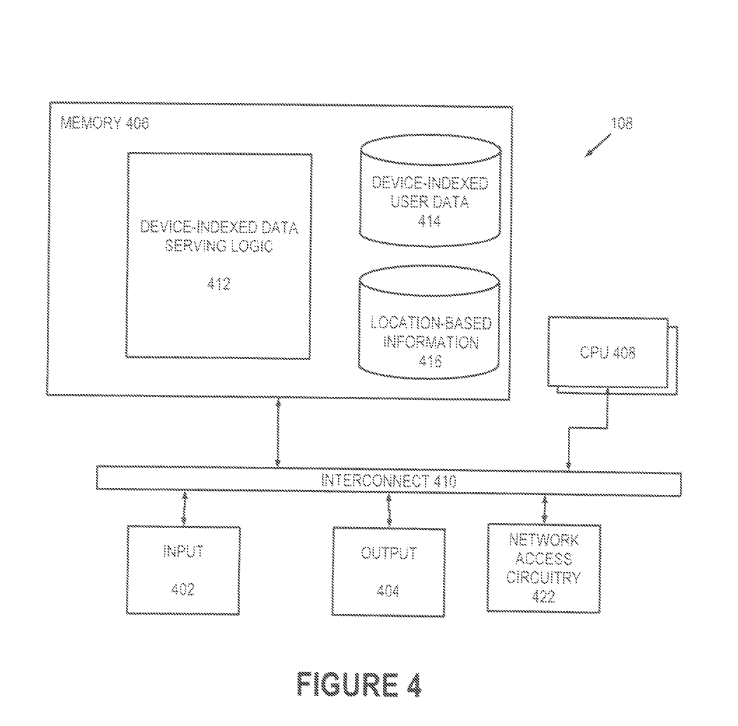

Device-indexed data server 108 is shown in greater detail in FIG. 4. Device-indexed data server 108 includes one or more microprocessors 408 (collectively referred to as CPU 408) that retrieve data and/or instructions from memory 406 and execute retrieved instructions in a conventional manner. Memory 406 can include generally any computer-readable medium including, for example, persistent memory such as magnetic and/or optical disks, ROM, and PROM and volatile memory such as RAM.

CPU 408 and memory 406 are connected to one another through a conventional interconnect 410, which is a bus in this illustrative embodiment and which connects CPU 408 and memory 406 to one or more input devices 402, output devices 404, and network access circuitry 422. Input devices 402 can include, for example, a keyboard, a keypad, a touch-sensitive screen, a mouse, and a microphone. Output devices 404 can include, for example, a display—such as a liquid crystal display (LCD)—and one or more loudspeakers. As device-indexed data server 108 is a server computer, input devices 402 and output devices 404 can be omitted. Network access circuitry 422 sends and receives data through wide area network 106 (FIG. 1) such as the Internet and/or mobile device data networks.

A number of components of device-indexed data server 108 are stored in memory 406. In particular, device-indexed data serving logic 412 is all or part of one or more computer processes executing within CPU 408 from memory 406 in this illustrative embodiment but can also be implemented using digital logic circuitry. As used herein, “logic” refers to (i) logic implemented as computer instructions and/or data within one or more computer processes and/or (ii) logic implemented in electronic circuitry. Device-indexed user data 414 and location-based information 416 are data stored persistently in memory 406. In this illustrative embodiment, device-indexed user data 414 and location-based information 416 are each organized as one or more databases.

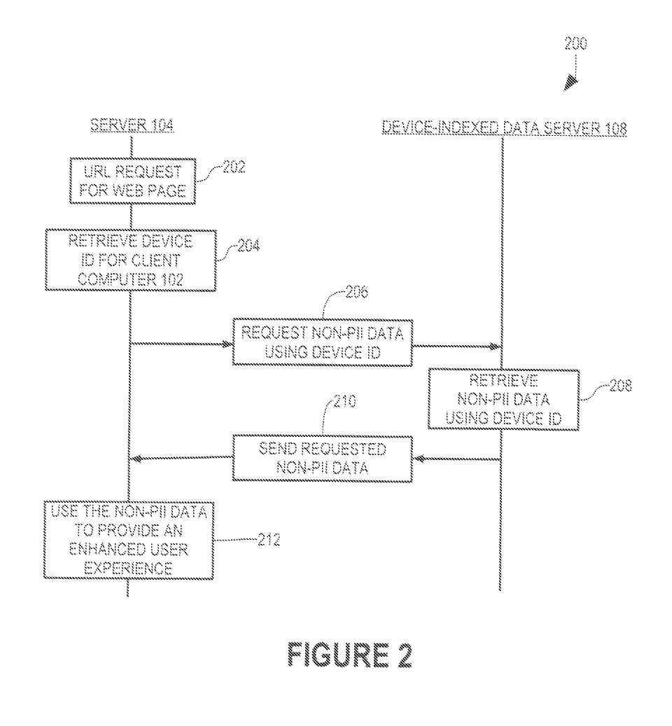

Transaction flow diagram 200 (FIG. 2) illustrates the cooperation of server 104 (FIG. 1) and device-indexed data server 108 to identify information about the user of client device 102 prior to authentication of the user such that server 104 can customize the experience of the user, even before the user has identified herself.

In step 202 (FIG. 2), server 104 receives a URL in a request from client device 102 according to any of a number of known network protocols. In this illustrative embodiment, the request is received according to the known HTTP or HTTPS protocol.

In step 204, server 104 retrieves an identifier of client device 102 itself In this illustrative embodiment, the identifier is a digital fingerprint of client device 102. Digital fingerprints are known and are described, e.g., in U.S. Pat. No. 5,490,216 (sometimes referred to herein as the '216 Patent), and in U.S. Patent Application Publications 2007/0143073, 2007/0126550, 2011/0093920, and 2011/0093701, the descriptions of which are fully incorporated herein by reference. There are a number of ways in which server 104 can retrieve a digital fingerprint of client device 102, one of which is described in U.S. Provisional Patent Application 61/474,146, which was filed Apr. 11, 2011 and which is fully incorporated herein by reference. Regardless of its manner of retrieval, the device identifier comprises a persistent identifier because it is derived from machine parameters (i.e. readable bytes of memory representing hardware or software configurations), a critical percentage of which are reliably not expected to change over the useful life of the computing device being identified, such that even if a percentage up to the critical percentage changes, the device identifier can be regenerated.

In step 206, server 104 requests from device-indexed data server 108 user data associated with the device identifier retrieved in step 204.

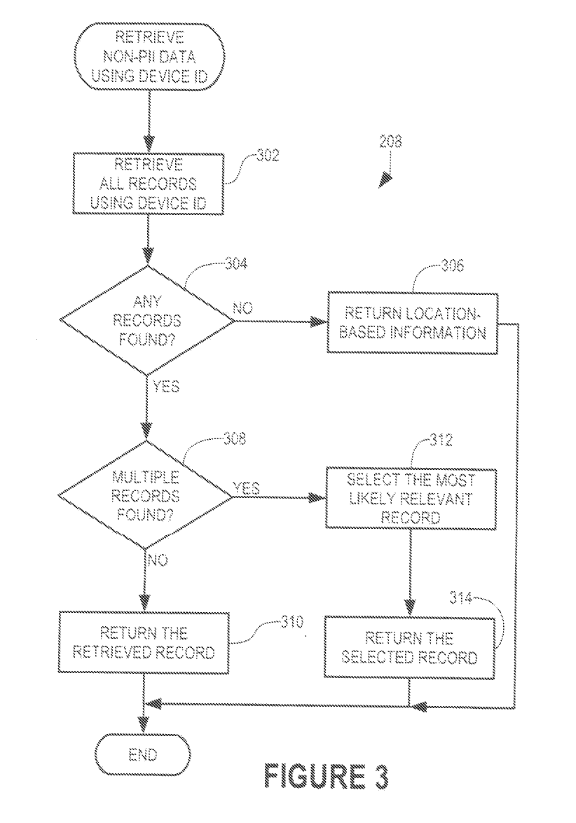

In step 208, device-indexed data server 108 retrieves data associated with client device 102 as identified by the device identifier received in step 206. Step 208 is shown in greater detail as logic flow diagram 208 (FIG. 3).

Referring now to FIG. 3, in step 302, device-indexed data serving logic 412 of device-indexed data server 108 retrieves all records from device-indexed user data 414 that are associated with the device identifier of client device 102.

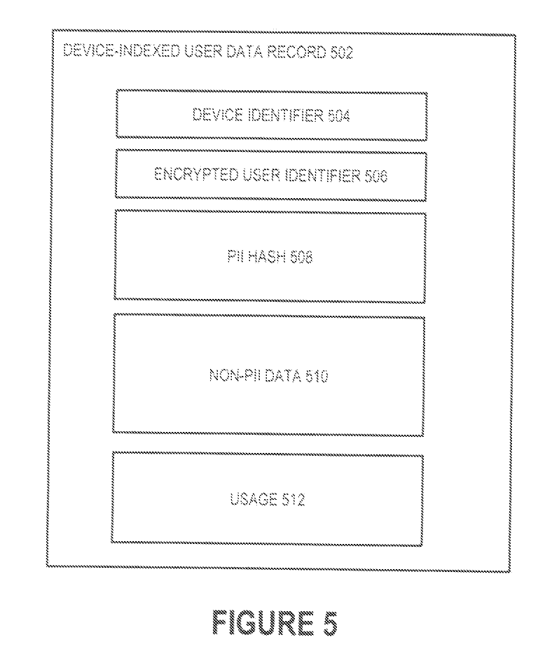

An example of such a record is shown in FIG. 5 as device-indexed user data record 502, which includes a device identifier 504, an encrypted user identifier (EID) 506, a PII hash 508, non-PII data 510, and usage data 512.

Device identifier 504 uniquely identifies a device with which data is associated within device-indexed user data 414 (FIG. 4). Encrypted user identifier 506 uniquely identifies a human user with whom data is associated within device-indexed user data 414. The combination of device identifier 504 and encrypted user identifier 506 is unique within device-indexed user data 414. In other words, there is only one device-indexed user data record in device-indexed user data 414 for any combination of a specific user and a specific device. However, a given device can be associated with multiple users in device-indexed user data 414, and a given user can be associated with multiple devices in device-indexed user data 414.

Encrypted user identifier 506 is encrypted to prevent device-indexed data server 108 from having access to personally identifiable information while still being able to uniquely, albeit anonymously, identify individual users. To the extent multiple servers such as server 104 use a common encrypted user identifier 506, device-indexed user data record 502 can be used across multiple servers. For example, the user identifier can be a canonicalized e-mail address (e.g., converted to all lower-case) encrypted in a manner shared by all such servers (e.g., an MD5 sum digest of the canonicalized e-mail address). Thus, choices made by the user with respect to server 104 can be used to customize the experience of the user with respect to a different server, and vice-versa.

In addition, PII hash 508 is an irreversible hash of personally identifiable information received from off-line data aggregator 110 in a manner described more completely below. Such further allows unique identification of individual users and proper association of subsequent data updates from off-line data aggregator 110 with the correct user. Since the hash is irreversible, device-indexed data server 108 has no access to any PII information from which the hash is formed. In this illustrative embodiment, PII hash 508 is an Abilitec Secure Hash. Both the encrypted user identifier 506 and the PII hash 508 are examples of non-PII identifiers.

Non-PII data 510 represents historical and statistical behavior of the user identified by, or associated with, encrypted user identifier 506 and does not include any information by which the user can be personally identified, i.e., it does not include any personally identifiable information.

Usage 512 includes data representing access history of device-indexed user data record 502. The access history can be a single time stamp of the most recent access of device-indexed user data record 502 or can be a number of time stamps of most recent access history.

In one embodiment, user-specific data—such as encrypted user identifier 506, PII hash 508, and non-PII data 510—are stored in a single database table, and device identifier 504 is stored in a separate database table, and the many-to-many relationship is represented in yet another table in which usage 512 is stored. Usage 512 represents the usage history of the subject device by the subject user.

As described above, device-indexed data serving logic 412 (FIG. 4) retrieves all records from device-indexed user data 414 that are associated with the device identifier of client device 102 in step 302 (FIG. 3) and multiple records of device-indexed user data 414 can be associated with the device identifier of client device 102, particularly if client device 102 is used by multiple individuals.

In test step 304, device-indexed data serving logic 412 determines whether any records are retrieved in step 302. If not, processing transfers to step 306. In step 306, since device-indexed user data 414 does not include any user data associated with the identifier of client device 102, device-indexed data serving logic 412 returns more general information corresponding to the client device 102. For example, it may return location-based data (e.g. a geographic location indicator such as IP address) or device-specific data such as device type (e.g. mobile device) and/or a device model (e.g. iPod). In particular, data serving logic 412 may estimate the location of client device 102 at least the postal code of the area in which client device 102 is estimated to be using conventional techniques and retrieves information associated within location-based information 416 (FIG. 4), returning the retrieved location-based information. Similarly, memory 406 may store information associated with the device-specific data and return such information relevant to a user of such a device.

Conversely, if at least one result is retrieved in step 302 (FIG. 3), processing transfers from test step 304 to test step 308 in which device-indexed data serving logic 412 determines whether multiple records are retrieved in step 302. If not, processing transfers to step 310 in which device-indexed data serving logic 412 identifies non-PII data 506 (FIG. 5) of the single returned device-indexed user data record retrieved in step 302.

Conversely, if device-indexed data serving logic 412 determines that multiple records were retrieved in step 302, processing transfers to step 312. In step 312, device-indexed data serving logic 412 selects one of the multiple retrieved records most likely to represent the current user of client device 102. In a simple embodiment, device-indexed data serving logic 412 selects the most recently accessed one of the records according to usage 512 of the multiple records. In other embodiments, device-indexed data serving logic 412 uses usage 512 of the multiple records to identify patterns of usage according to times of day and days of the week. In addition, device-indexed data serving logic 412 can over-ride such complex usage pattern recognition if the most recent usage among the multiple retrieved records is below a predetermined threshold, e.g., five (5) minutes, suggesting continued use of client device 102 by the same user. In more elaborate embodiments, device-indexed data serving logic 412 may return a record according to psychographic criteria associated with the device identifier, as disclosed in U.S. Provisional Patent Application 61/383,676, which was filed Sep. 16, 2010, and which is fully incorporated herein by reference.

Processing transfers from step 312 to step 314 in which device-indexed data serving logic 412 identifies non-PII data 506 (FIG. 5) of the device-indexed user data record selected in step 312. After step 306 or step 310 or step 314, processing according to logic flow diagram 208, and therefore step 208 (FIG. 2), completes.

In step 210, device-indexed data serving logic 412 of device-indexed data server 108 returns the non-PII data retrieved in step 208 to server 104. In step 212, server 104 uses the non-PII data to provide an enhanced user experience for the user of client device 102 prior to authentication of the user.

The enhanced user experience can include links to information likely to be of particular interest to the user, targeted advertisements for goods and services indicated by the non-PII to be of interest to the user, and similar information such as reviews and recommendations of similarly minded users. For example, if server 104 provides on-line banking services and the user of client device 102 had been recently visiting web sites of automobile manufacturers and reading automobile reviews on-line, the user's initial contact with server 104 can provide information regarding vehicle loans, even before the user has identified herself. In another example, server 104 may provide advertisements for products designed specifically for users of the particular type or model identified as being device 102. Many other user-enhancing responses of server 104 are possible within the scope of the disclosed subject matter, and are not limited only to services associate with business transactions. For example, server 104 may return a web page having a particular artwork or theme or language associated with the location of device 102. In another example, server 104 may return content in a format compatible with, or specifically designed for, the particular technology of device 102.

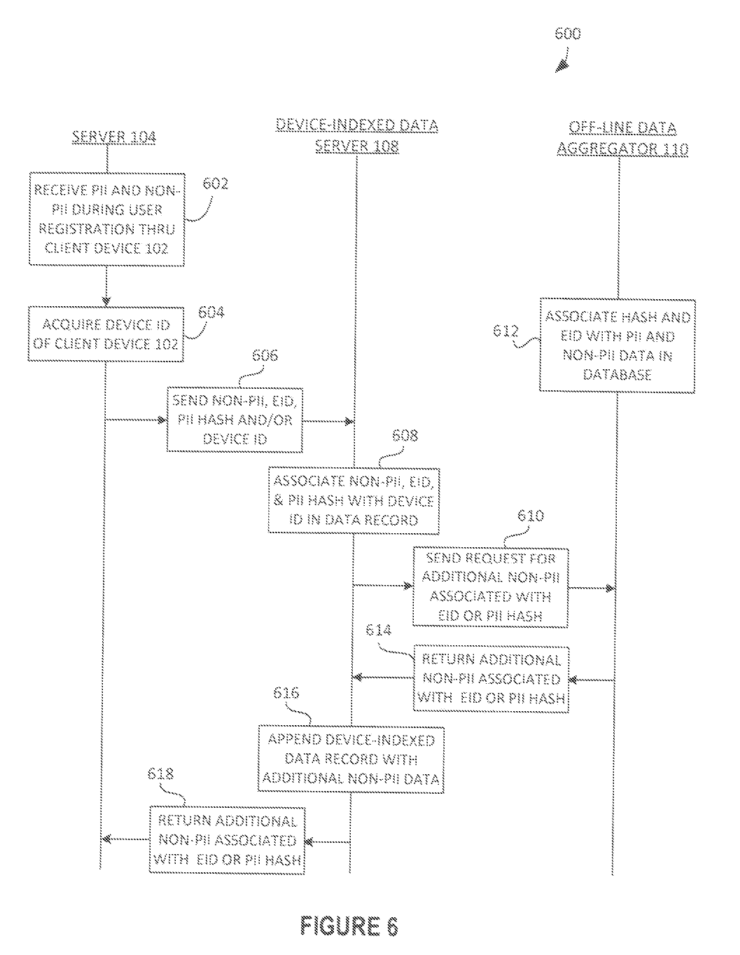

Transaction flow diagram 600 (FIG. 6) illustrates cooperation between server 104, device-indexed data server 108, and off-line data aggregator 110 to form device-indexed user data record 502 (FIG. 5) for a newly-registered user. In general, the servers cooperate so that, when a resource request is received at server 104 from a user of client device 102, server 104 can request additional non-PII information about the user from server 108, using the device ID, PII hash, or EID of the user as the basis of the request. Server 108, in turn, requests the additional non-PII data from aggregator 110, using the EID or PII hash as the basis of its request. In a preferred embodiment, server 108 is the custodian of device IDs, and aggregator 110 is the custodian of PII. Server 108 acts as a liaison between server 104 and aggregator 110 so that server 108 never receives PII from aggregator 110, and aggregator 110 never receives a device ID from server 104. A more specific description of this interaction is provided in the following discussion, which illustrates the salient steps in a method according to the disclosed subject matter.

In step 602, server 104 receives information from the user through client device 102 during user registration. The information received may include both PII and non-PII data. From the PII data, the server 104 may generate an EID 506 or PII hash 508 during this step.

In step 604, server 104 retrieves the device identifier of client device 102 (if possible) in the manner described above with respect to step 204 (FIG. 2).

In step 606, server 104 sends one or more of the non-PII data, the device identifier of client device 102, the EID 506, and PII hash to device-indexed data server 108, in the form of a request for additional non-PII information.

In step 608, device-indexed data server 108 stores the non-PII data, the EID 506, the PII hash 508, and the device identifier of client device 102 in device-indexed user data 414 (FIG. 4) in the form of device-indexed user data record 502 (FIG. 5). Record 502 maintains associations among all of these identifiers. For example, if the EID 506 is known, a device identifier and non-PII data associated with that EID can be retrieved from the device-indexed user data record.

In step 610, device-indexed data server 108 forwards the request to the off-line data aggregator 110 for additional non-PII data that is associated with the EID 506 or with the PII hash 508 that was generated or received in step 602.

In step 612, off-line data aggregator 110 gathers and maintains information regarding the usage habits and patterns of numerous users. Examples of off-line data aggregators include Acxiom Corporation of Little Rock, Arkansas; Experian Information Solutions, Inc. of Costa Mesa, Calif.; and Equifax Inc. of Atlanta, Ga. The information maintained by off-line data aggregator 110, including PII, may be obtained from many different sources at many different times, and may be indexed, for example, according to an EID or PII hash. The PII hash and EID may be generated independently from server 104 by the off-line data aggregator.

In step 614, off-line data aggregator 110 returns information requested by device-indexed data server 108 to the server 108. The information returned may be, for example, a complete record of non-PII data stored by the aggregator 110 that is associated with one or both of the PII hash and the EID.

In step 616, device-indexed data server 108 appends the data record for the device ID of client device 102 with any new non-PII data received from the off-line data aggregator 110.

In step 618, device-indexed data server 108 returns a complete record of non-PII data associated with the device ID of client device 102. Thereafter, device-indexed data server 108 can interact with server 104 in the manner described above with respect to transaction flow diagram 200 (FIG. 2) regarding interaction with client device 102 and the user identified by the device ID.

The system or method of the disclosed subject matter can initially provide non-PII data for many users by performing the transaction represented by flow diagram 600 without a persistent device identifier. This allows the disclosed subject matter to advantageously serve the large amount of user data collected independently by the off-line data aggregator 110 (e.g. in step 612) prior to the device-indexed data server 108 recording a device ID. This may occur, for example, when a user fails to complete the registration process to an extent necessary to fingerprint the client device 102, such that only PII data such as a user name or e-mail address is received at server 104. By performing steps 608-616 for each of the numerous users and leaving the device identifier unspecified, device-indexed data server 108 can accumulate numerous records such as data-indexed user data record 502 (FIG. 5) in which device identifier 504 is null, i.e., identifying no device. In such a record, the PII hash or EID may be used as a temporary means of uniquely indexing the record and requesting additional non-PII data from an off-line data aggregator 110.

Device-indexed data server 108 can later associate each of the data-indexed user data records with a device identifier when the device identifier becomes available as each user completes the registration process and is fully authenticated (and their device 102 fully fingerprinted) by server 104. For example, in step 606, when a request containing both an EID and a device ID is received by the server 108, and where no record of that device ID already exists but where a record exists for the EID, the server 108 can update the record with the device ID and return any non-PII data associated with that record. This promotes within server 108 the ability to associate non-PII with the more persistent index of a device ID, rather than with a non-PII identifier that is less persistent. For example, if the index is an EID derived from an e-mail address, the longevity of the EID depends only on however long the user maintains that particular e-mail address as her preferred contact data. If the index is the device ID, it remains persistent as long as the device remains in service.

Of course, there will be cases in which an EID persists beyond the service life of a device ID. The disclosed subject matter advantageously associates all available non-PII identifiers with a device identifier, so that if the client device associated with the device identifier is retired, the data record 502 will still remain and can still be retrieved using the non-PII identifier. This will occur according to process 600 for the case where a prior user with a new, unrecognized (i.e. null) device first registers onto a server 104. When the device is eventually fingerprinted and the device ID sent to server 108, it will be associated with the non-PII data, EID, and PII hash in step 608 in a new data record. An additional step (not shown) may be executed to reconcile the data stored in user data records 502 that have the same non-PII identifiers but different device IDs.

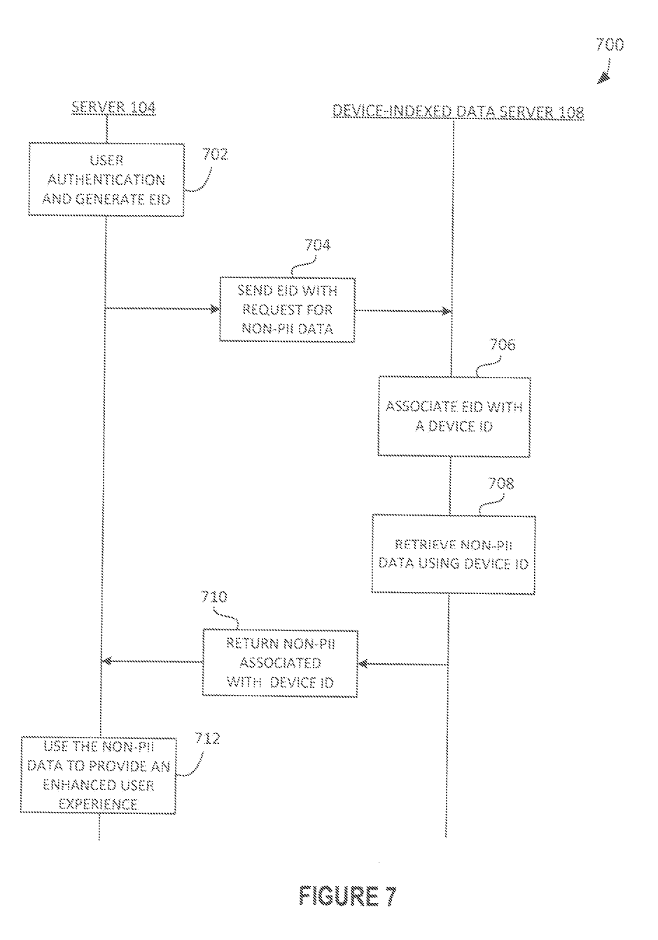

For users requesting resources from any server in communication with device-indexed data server 108, which users have already been fully authenticated (e.g., by server 104), and whose client devices have been previously fingerprinted and indexed in device-indexed data server 108, non-PII data about those users can be returned to a requesting server on the basis of the EID alone, or on the basis of the PII hash alone. This process is depicted in flow diagram 700 (FIG. 7), for the case where non-PII data is requested solely on the basis of the EID. Of course, the process may be applied equally for cases in which non-PII data is requested solely on the basis of the PII hash, or on the basis of some other non-PII indicia that is recognized by device-indexed data server 108 and associated with a device ID in a device-indexed data record.

In step 702, server 104 authenticates the user of client device 102 in a conventional manner and generates an EID of the user, where the EID may be derived, for example, from an e-mail address. In step 704 (FIG. 7), server 104 sends the EID in a request for non-PII data about the user.

In step 706, device-indexed data server 108 receives the request and associates the received EID with a device ID. In particular, device-indexed data server 108 searches device-indexed user data 414 (FIG. 4) for a device-indexed user data record 502 (FIG. 5) in which EID 506 matches the EID received in step 706. For example, a user data record 502 may have been previously created through interaction of some other web server (not shown) with server 108. During that interaction, an EID was created for the same user in a recognized format, such as the Abilitec Secure Hash format, the device-indexed user data record 502 was created on that basis, and any non-PII data that may have been captured at the time was stored in the data record. On the other hand, if no such device-indexed user data record exists, a new device-indexed user data record is created.

In step 708, device-indexed data server 108 retrieves non-PII data for the subject user by use of the device identifier in the manner described above with respect to step 208 (FIG. 2) and logic flow diagram 208 (FIG. 3). If the non-PII data about the user identified by the EID received in step 706 already exists in device-indexed user data 414, and that information is already associated with a device identifier, non-PII data can be immediately returned, as in step 710, to server 104 with an instruction to server 104 not to request or generate a new device fingerprint for client device 102.

In step 710 (FIG. 7), device-indexed data server 108 sends the requested non-PII data to server 104. In step 712, the server 104 uses the non-PII data to provide an enhanced user experience in the manner described above with respect to step 212 (FIG. 2).

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for serving user behavior data corresponding to a human user of a device in the absence of authentication of the user, the method comprising:
receiving a request through a computer network for the user behavior data, wherein the user behavior data represents behavior of the user and wherein the request includes an identifier of the device;
retrieving the user behavior data through an association between the user behavior data and the identifier of the device stored in a computer; and
sending the user behavior data through the computer network in response to the request.

2. The method of claim 1 wherein the identifier of the device is a digital fingerprint of the device.

3. The method of claim 1 wherein the user behavior data does not personally identify the user.

4. The method of claim 1 further comprising:
receiving the user behavior data from an off-line data aggregator.

5. A computer readable medium useful in association with a computer which includes one or more processors and a memory, the computer readable medium including computer instructions which are configured to cause the computer, by execution of the computer instructions in the one or more processors from the memory, to serve user behavior data corresponding to a human user of a device in the absence of authentication of the user by at least:
receiving a request through a computer network for the user behavior data, wherein the user behavior data represents behavior of the user and wherein the request includes an identifier of the device;
retrieving the user behavior data through an association between the user behavior data and the identifier of the device stored in a computer; and
sending the user behavior data through the computer network in response to the request.

6. The computer readable medium of claim 5 wherein the identifier of the device is a digital fingerprint of the device.

7. The computer readable medium of claim 5 wherein the user behavior data does not personally identify the user.

8. The computer readable medium of claim 5 wherein the computer instructions are configured to cause the computer to serve user behavior data corresponding to a human user of a device in the absence of authentication of the user by at least also:
receiving the user behavior data from an off-line data aggregator.

9. A computer system comprising:
at least one processor;
a computer readable medium that is operatively coupled to the processor;
network access circuitry that is operatively coupled to the processor; and
device-indexed data serving logic (i) that executes in the processor from the computer readable medium and (ii) that, when executed by the processor, causes the computer to serve user behavior data corresponding to a human user of a device in the absence of authentication of the user by at least:
receiving a request through the network access circuitry for the user behavior data, wherein the user behavior data represents behavior of the user and wherein the request includes an identifier of the device;
retrieving the user behavior data through an association between the user behavior data and the identifier of the device stored in a computer; and
sending the user behavior data through the network access circuitry in response to the request.

10. The computer system of claim 9 wherein the identifier of the device is a digital fingerprint of the device.

11. The computer system of claim 9 wherein the user behavior data does not personally identify the user.

12. The computer system of claim 9 wherein the device-indexed data serving logic is configured to cause the computer to serve user behavior data corresponding to a human user of a device in the absence of authentication of the user by at least also:
receiving the user behavior data from an off-line data aggregator.
